(19) United States
(12) Patent Application Publication
(10) Pub. No.: US 2011/0259923 A1
(43) Pub. Date: Oct. 27, 2011

(54) Plug And Valve System

(76) Inventors: John Geoffrey Chan, Maineville, OH (US); Lawrence Edward O'Brien, Cincinnati, OH (US)

(21) Appl. No.: 13/092,577

(22) Filed: Apr. 22, 2011

Related U.S. Application Data
(60) Provisional application No. 61/327,981, filed on Apr. 26, 2010.

(51) Int. Cl. B67D 7/06; F16K 51/00

(52) U.S. Cl. 222/402.1; 251/118; 222/402.21

(57) ABSTRACT

A plug for use in a valve system comprising a generally elongate elastically deformable plug body having a longitudinal axis and a first end and an opposing second end, said body forming a blind hole disposed extending in a longitudinal direction downwards from said first end, a flange juxtaposed with said first end and extending radially outboard, wherein said plug forms at least one orifice at least partially formed in said flange, whereby said plug is longitudinally elastically elongatable.

### CROSS REFERENCE TO RELATED APPLICATIONS

This application claims the benefit of U.S. Provisional Application No. 61/327,981 filed Apr. 26, 2010.

### FIELD OF THE INVENTION

The present invention is directed to plugs and valve systems that can be employed in a variety of host devices and used in a number of different applications, including, for example, containers and dispensers associated with consumer products.

### BACKGROUND

Pressurized packages for consumer goods include aerosol cans. Aerosol cans typically have valve systems which have multiple parts and can be complex to manufacture and assemble. Nonlimiting examples of known valve systems used in aerosol cans include: U.S. Pat. Nos. 3,357,604; 3,477,613; 3,586,068; 3,817,429; 3,845,887; 4,122,982; 5,427,282; 6,006,745; and 6,474,513.

Some of valve systems have even been disclosed as one piece grommets or seals made of rubber or other synthetic materials. See e.g., U.S. Pat. Nos. 4,008,834; 6,113,070; and 6,918,516. Many attempts to use rubber parts in the dispensing system, however, relate to tips and applicators. There remains a need for a simple to manufacture and low cost valve system suitable for use in a wide variety of pressurized packages of consumer goods.

### BRIEF DESCRIPTION OF THE DRAWINGS

While the specification concludes with claims particularly pointing out and distinctly claiming the subject matter which is regarded as forming the present invention, it is believed that illustrative embodiments of the present invention may be better understood from the following description taken in conjunction with the accompanying drawings, in which:

FIG. 1 is a side view of a container including an exemplary valve embodiment of the present invention.

FIG. 2 is a partial cross-sectional view of the container and valve shown in FIG. 1.

FIG. 3 is a cross-sectional view of a second exemplary valve embodiment.

FIG. 4 is a cross-sectional view of a third exemplary valve embodiment.

FIG. 5 is a cross-sectional view of the valve shown in FIG. 2 in an open position.

FIG. 6 is a cross-sectional view of the valve shown in FIG. 2 and including a tube, such as that associated with an actuator, inserted into the valve.

FIG. 7 is a cross-sectional view of a fourth exemplary valve embodiment.

FIG. 8 is a cross-sectional view of a fifth exemplary valve embodiment.

FIG. 9 is a cross-sectional view of an exemplary dispenser provided by the present invention.

FIGS. 10A and 10B are side views of two tubes, each in accordance with at least one embodiment of the present invention.

FIG. 11 is a top planar view of a plug in accordance with at least one embodiment of the present invention.

FIG. 12 is a side planar view of a plug in accordance with at least one embodiment of the present invention.

FIGS. 13 and 14 are two side views of plugs in accordance with at least one embodiment of the present invention.

FIG. 15 is a side view of plug in accordance with the present invention with a tube present therein.

FIG. 16 shows the plug of FIG. 15 in a longitudinally deformed state.

FIGS. 17 and 18 are side views of another plug of the present invention.

FIGS. 19 and 20 are top and cross sectional views of a yet another plug in accordance with the present invention, respectively.

FIGS. 21 and 22 are additional top view of further plugs in accordance with the present invention.

FIG. 23 is a cross sectional view of yet another plug in accordance with the present invention.

FIGS. 24 and 25 are two cross sectional views of yet other plugs in accordance with the present invention, in an un-deformed state and in a longitudinally deformed state, respectively.

FIG. 26 is a cross sectional view of a plug having a flange with a tapered shape.

### SUMMARY OF THE INVENTION

One aspect of the present invention provides for a plug for use in a valve system and selectively blocking and admitting fluid flow from a high pressure side of said plug to a low pressure side of said plug when inserted into a plug receiving member, said plug comprising: a generally elongate elastically deformable plug body having a longitudinal axis, a first end, a second end longitudinally opposed thereto, and a peripheral outer sidewall, said outer sidewall sealingly engaging an inner wall of a plug receiving member when said plug is inserted therein; a blind hole disposed in said first end and extending in the longitudinal direction to a blind end, said hole defining an inner sidewall in said elongate body; and a flange juxtaposed with said first end and extending radially outboard of said outer wall, said flange having an inner flange wall and an outer flange wall; wherein said plug forms at least one orifice extending from at least one of said outer sidewall, said inner flange wall, or a combination thereof, to at least one of said inner sidewall, said outer flange wall, or a combination thereof, preferably at least partially formed in said flange, whereby said plug is longitudinally elastically elongatable in response to longitudinal force applied to said blind end of said blind hole; said plug radially contracting in response to said longitudinal elongation, said radial contraction creating a fluid flowpath from said second end to said first end.

Another aspect of the present invention includes a valve system comprising: a plug in accordance with the present invention; and a plug receiving member comprising an inner wall such that said outer sidewall of said plug sealingly engages at least a portion of said inner wall of said plug receiving member when said plug is inserted therein.

### DETAILED DESCRIPTION OF THE INVENTION

As defined herein, a valve or valve system refers to a plug and plug receiving member. Examples of valves and valve systems are disclosed in U.S. Patent Publ. No. 2010/0133301. The valves and valve systems of the present invention are suitable for use in various material dispensing systems including but not limited to those disclosed in U.S. Patent Publ. No. 2010/0133295. The present invention may be understood more readily by reference to the following detailed description of illustrative and preferred embodiments. It is to be understood that the scope of the claims is not limited to the specific components, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values form another embodiment. All ranges are inclusive and combinable.

The present invention is directed to valves useful for the control of material flow therethrough. The valves can be used in a variety of applications, including, for example, in containers for dispensing consumer products. Preferred valve embodiments generally employ an elastically deformable member that seals against complementary components to form a valve closed or reduced flow position. Stress can be applied to the elastically deformable member whereby dimensional changes occur to release sealed areas to define flow paths through the valve, thereby converting the valve from a normally closed position to an open position.

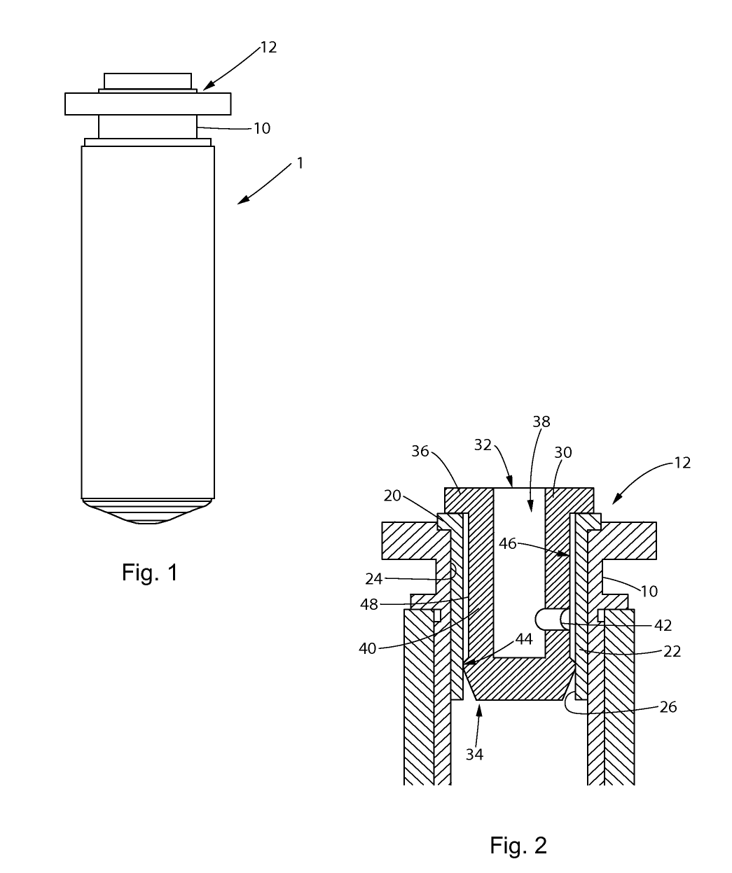

With reference now to the figures, and in particular FIG. 1, a material dispensing system 1 is shown, which includes a container preform 10 and a valve system 12, created by compression molding technology, disposed within a top opening of preform 10. Although not critical to or limiting on the claimed valves, container preform 10 can be created with injection molding technology, and then subsequently blow molded or otherwise formed into a final collapsible container (not shown). As shown in FIG. 1, container preform 10 is surrounded by an elastic band which is expandable with the container so as to provide the driving force for dispensing material charged into the final container.

A cross-sectional view of exemplary valve system 12 is shown in FIG. 2, and includes a plug 30 positioned within a plug receiving member 20, shown here as a sleeve which can be separate from the container which the valve system can be placed. Suitable plug receiving members include any structure which is able to retain said plug in a complementary relationship such that the plug is secure in the receiving member and the flange allows the plug to be anchored from lateral displacement. Those of skill in the art will understand that anchoring the flange will allow the second end of the plug to deform laterally away from the first end without the entire plug being moved. Nonlimiting examples of suitable plug receiving members include sleeves which can be then placed into a device, such as shown in FIG. 2, as well as bottle necks or other integrally formed parts of the dispensing device. Plug receiving member 20 of FIG. 2 comprises a plug receiving member wall 22, and outer surface 24 that abuts the opening formed in container preform 10, and an inner surface 26 that cooperates with plug 30 to form a seal in the valve system's normally closed position. Plug 30 has a first open end 32 and an opposing closed end 34.

In one embodiment, a flange 36 is defined proximate first end 32. The flange need not extend 360 degrees around the entire plug but should be of sufficient dimensions to keep the plug in place in the presence of a longitudinal downward force—thereby allowing the plug to become stressed and deform longitudinally and contracting radially. Further, in one embodiment, the flange does not form the topmost portion of the plug. The generally elongate elastically deformable plug body can extend towards to top end beyond the flange. (See for example FIG. 23). In another embodiment, the flange can have a cross sectional shape which is different from the general cross sectional shape of the generally elongate elastically deformable plug body of the plug.

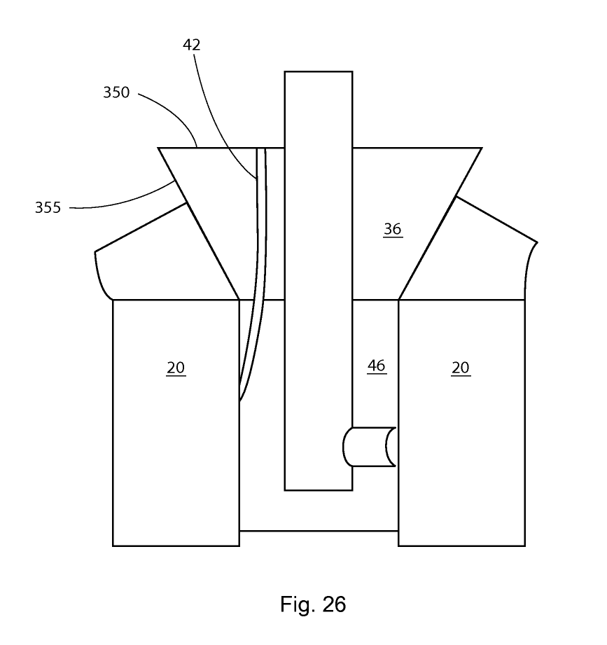

Those of skill in the art will understand that depending on the relationship between the plug and the plug retaining member, the flange can be of various shapes as long as the plug can be retained in the plug retaining member in a generally stationary position yet allowing deformation of the plug body in the longitudinal direction with radial contraction. In one embodiment, the flange is a cylindrical structure formed around at least a part of the plug. The flange can also have a tapered shape as shown in FIG. 26.

A blind hole 38 extends into plug 30 from first end 32 to define an inner side wall 40. At least one orifice 42 extends through inner side wall 40. A blind hole, as defined herein is a hole which is disposed longitudinally into said plug. In one embodiment, the blind hole has a longitudinal axis which is substantially parallel to the longitudinal axis of the plug. Radially or radial, as defined herein refers to a direction generally perpendicular to the longitudinal axis and applies to any plug shape suitable for use herein (including but not limited to cylindrical plugs).

An orifice, as defined herein forms a flow passage which allows a fluid contained within the container to pass through the plug. In one embodiment, the plug forms at least one orifice (42) extending from at least one of said outer sidewall (46), said inner flange wall (355), or a combination thereof, to at least one of said outer sidewall (61), said outer flange wall (350), or a combination thereof. Said at least one orifice 42 is illustrated in this figure as a radial hole from the outer sidewall to the inner sidewall. Said at least one orifice could also be a slit, a hole, or other structure that extends through inner side wall 40, which appears to be closed or sealed against the outer wall of the plug retaining member, but can become opened when plug 30 is elastically deformed. In one embodiment, the seal is such that fluid does not pass through when the valve system is in an unstressed state. In one embodiment the seals are substantially water tight. The skilled artisan would appreciate that more than one orifice can be employed. In one embodiment, said at least one orifice is at least partially formed in said flange, forming a flange orifice extending from said inner flange wall (355) to said to at least one of said outer sidewall (61), said outer flange wall (350), or a combination thereof. Combinations of flange orifices and orifices formed in the side wall of the generally elongate elastically deformable plug body are within the scope of the invention (see FIG. 14). In one embodiment, the flange orifice is a slit or hole through said flange. In another embodiment, the flange orifice can be a notch formed in the periphery of said flange.

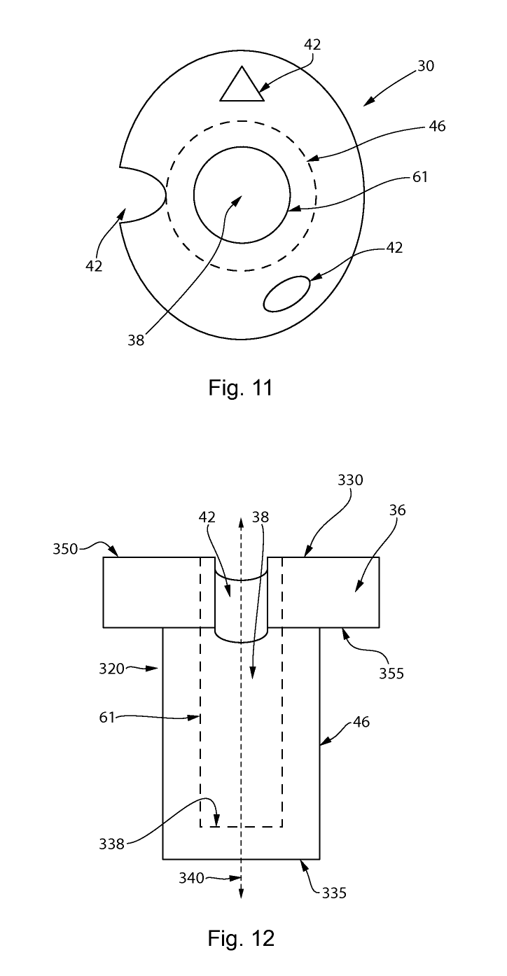

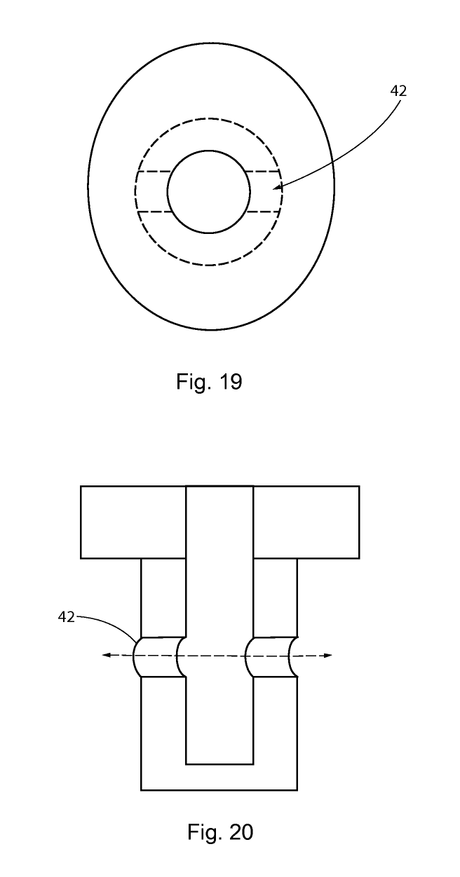

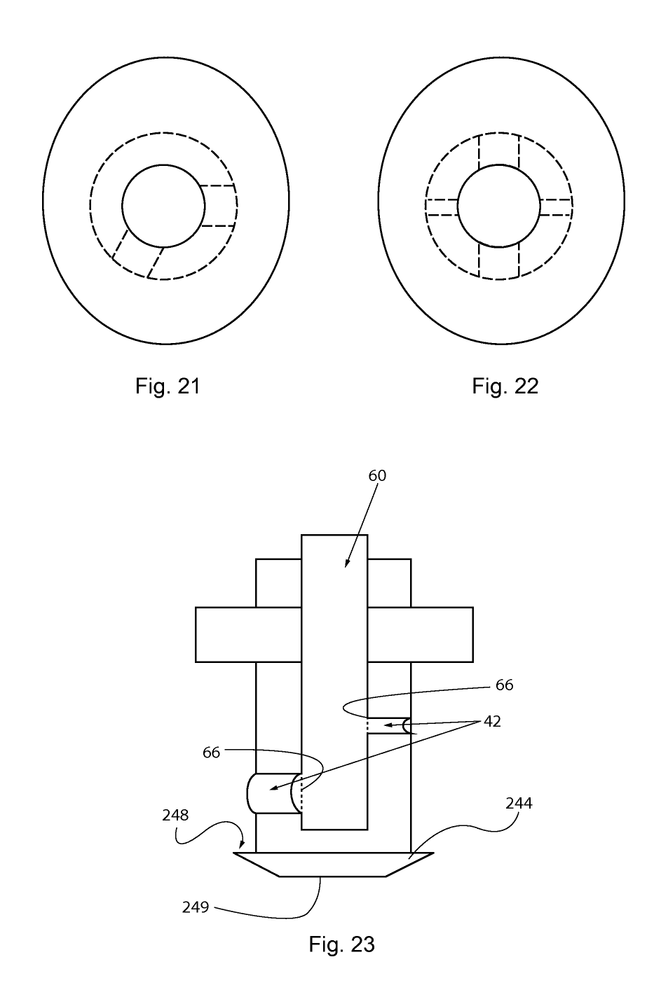

Said at least one orifice can be of the same shape or have different shapes (See FIG. 11). Said at least one orifices can also have the same cross sectional area or have varying cross section areas (See FIGS. 22 and 23). In one embodiment, where said at least one orifice comprises more than one radial orifices, the orifices can be diametrically opposed to form a diametric orifice (See FIGS. 19 and 20). In another embodiment, where a plurality of radial orifices are formed in the side wall, they can be equally circumferentially spaced apart or unequally spaced apart (See FIG. 20 vs. FIG. 21). Various combinations of orifice placement and alignment are possible and within the scope of the present invention. Those of skill in the art will understand that the selection of the type of orifice (flange orifice, radial orifice, or an orifice which is formed by both the flange and sidewall of the generally elongated elastically deformable plug body can allow for varying flow behavior. These combinations of orifices are within the scope of the present invention.

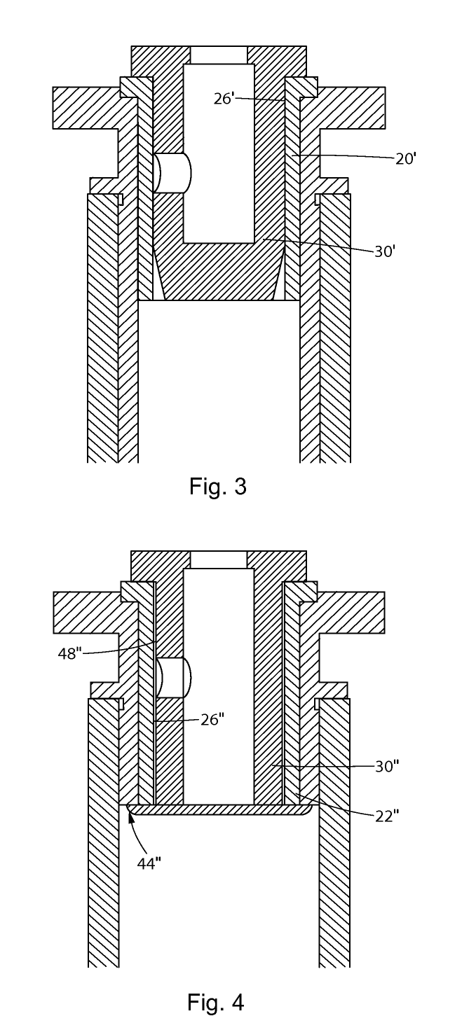

In one embodiment, as shown in FIG. 2, plug 30 contains an outer sidewall 46. A portion of said outer sidewall can have increased diameter (such as an annular ring (44)) that is sealable against the inner surface 26 of plug receiving member 20 when valve system 12 is in a closed position. The outer sidewall 46 itself can also act to sealingly engaging an inner wall (26) of a plug receiving member when said plug is inserted therein. Where an annular ring is used, the gap 48 formed between the rest of the outer sidewall 46 and the inner wall of the plug receiving member can help with sticking issues when attempting to convert the valve from a closed position to an open position. In an alternative embodiment that is shown in FIG. 3, a gap does not exist, whereby the entire (or nearly entire) exterior portion of the plug 30′ that faces the inner surface of the plug receiving member 20′ is sealed against the inner surface 26′. In yet another embodiment that is shown in FIG. 4, a gap 48″ exists along the entire length of the plug 30″ that faces the plug receiving member inner surface 26″, and a second flange 322 juxtaposed with said second end, said second flange having an end surface and an underside surface opposed thereto, said underside surface of said second flange sealingly engaging a surface when said plug is inserted in a valve system, wherein said underside of said second flange moves longitudinally away from said first end in response to longitudinal force applied to said blind end of said blind hole. The second flange 244 has an increased diameter section 44″ exists at a distal section of the plug 30″ so as to seal against the lower rim of the plug receiving member wall 22″.

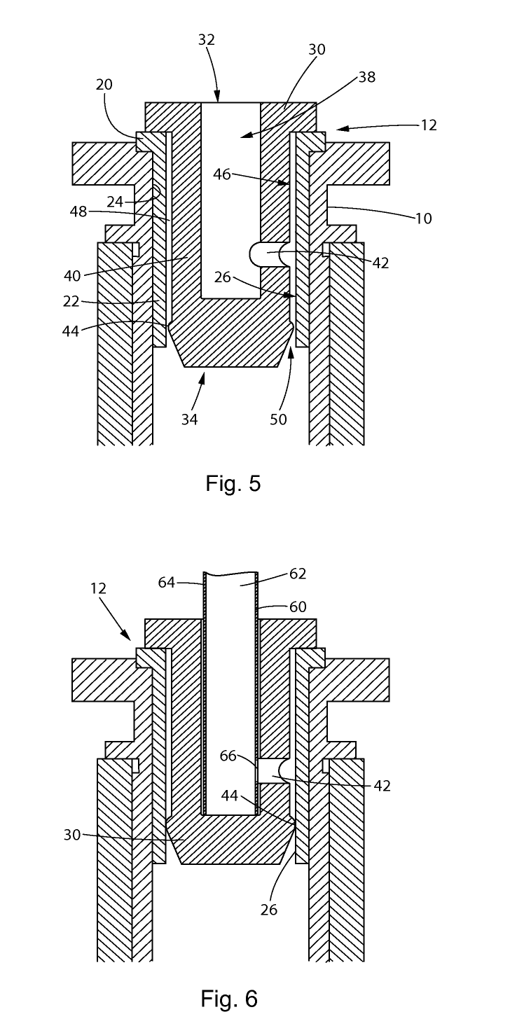

Plug 30 is shown in FIG. 2 in an unstressed state, and thus, valve system 12 is illustrated in its normally closed position. Plug 30 is elastically deformable, and with a sufficient amount of stress, can elongate (stretch) lengthwise. This elongation or stretching increases the plug's length while decreasing its effective diameter. And the reduction in the plug's effective diameter causes outer sidewall 46 or in this case annular ring 44 to release from the inner surface 26 sufficiently to create a flow channel 50 between plug 30 and plug receiving member 20 that is in fluid communication with said at least one orifice 42 and blind hole 38. Referring now to FIG. 5, valve system 12 accordingly is accordingly converted from a closed position to an open position as flow channel 50 is created. The skilled artisan would readily appreciate that alternative plug embodiments may elastically deform in ways other than or in addition to that described above to establish an open valve position.

Valve systems of the present invention may be used during the filling operations of containers, wherein flowable or dispensable compositions can be charged into a container employing the valves and the compositions maintained by the closed valve until dispensing is desired. In this application, with reference to exemplary valve system 12 for example, the pressurized composition is introduced into blind hole 38 to create the necessary stress level to elongate plug 30 to the extent that outer sidewall 46 or in this case annular ring 44 releases from plug receiving member inner surface 26 to create the flow channel between the plug and plug receiving member. The pressurized composition is then permitted to enter into the container's available fillable volume by flowing through the valve.

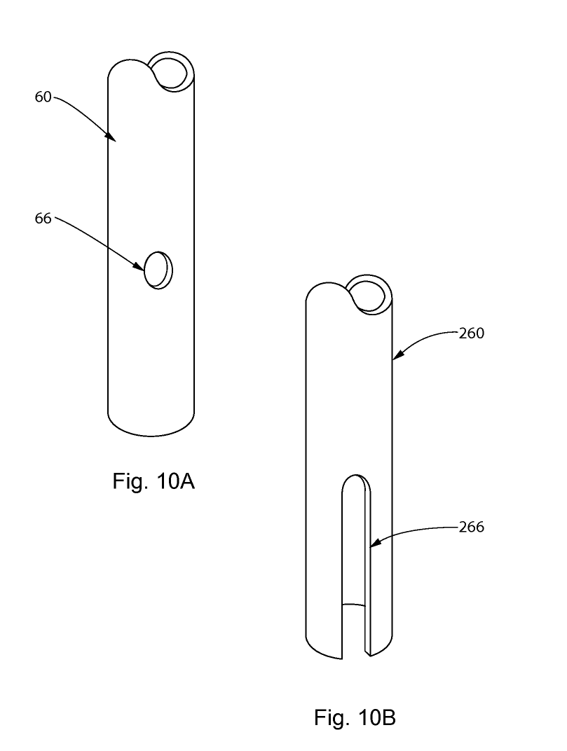

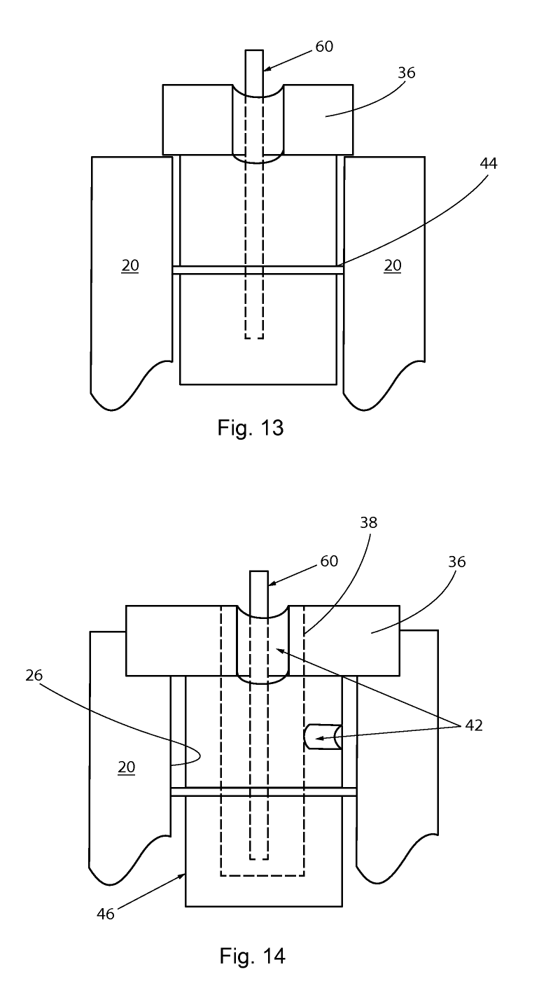

Other origins of stress can be used to convert the valve from a closed position to an open position. For example, and with reference to FIG. 6, exemplary valve system 12 is shown with a tube 60 that is partially disposed within blind hole 38. Tube 60 can form all or part of a conduit associated with an actuator/nozzle component for dispensing compositions from a container employing valves of the present invention. Tube 60 comprises an internal channel 62 which defines a tube side wall 64. In one embodiment, at least one tube orifice, such as radial hole 66 extends through tube side wall 64 so as to be able to communicate flowable materials between said at least one orifice 42 that is defined in the inner side wall 40 and internal channel 62. The through hole 66 can be larger in diameter or size verses the said at least one orifice 42 that is defined in the plug so that it can reduce alignment issue when the valve is stressed during dispensing. Also the through hole 66 can be an open ended slot extending from downwards towards the bottom of the tube 226. FIGS. 10A and 10B provides two examples of a tube 60 (FIG. 10A) which has a through hole 66 and tube 260 (FIG. 10B) which has a through hole 266 which is in the form of a open ended slot on the right. Downward displacement of tube 60 provides the needed stress to elongate plug 30 sufficiently to release outer sidewall 46 from the plug receiving member inners surface 26 to open the valve. The tube can be made from a variety of materials, including, for example, metal, glass, and plastic. The tube can be sized to provide a relatively tight fit within the plug orifice. And the tube and/or plug orifice may employ various features, such as at least one annular ring, alternatively more than one such as two or three, to effectuate a seal between the tube and the orifice to minimize leakage around the tube and out of the plug orifice. The tube can fill the entire volume of the blind hole, or can have a smaller diameter than said blind hole. Compare FIG. 13 to FIG. 14. In another embodiment, where a flange orifice is present, the area in the vicinity of said first end and exterior to said flange can be a fixed volume such that any fluid released into said area could then be directed into an tube orifice or other dispensing means to allow the fluid to be released out of the device and away from the first end.

Referring back to FIG. 6, tube through hole 66 is shown as being both in axial alignment and circumferential alignment with plug said at least one orifice 42 when the plug is in an unstressed state. The tube through hole may however be out of alignment with the plug flow passage. The tube may be sufficiently rotatable within the plug orifice to enable the tube through hole to be circumferentially out of alignment (partially or completely) with the plug flow passage to provide a “locking mechanism” to minimize or eliminate material dispensing when the tube is displaced inadvertently. Similarly, the tube through hole may be axially out of alignment (partially or completely) with the plug flow passage when the plug is unstressed; and alignment occurs when the plug is stressed and elongated/stretched. In another embodiment, where the diameter of the blind hole is larger than the diameter of the tube, the blind hole can be sealed at the first end such that when the plug is stressed and thereby deformed laterally, any fluid passing through the radial orifice can fill the blind hole and enter the tube orifice (regardless of the alignment of the tube orifice to the radial orifice.

As shown in FIG. 2, optional plug receiving member 20 serves as an annular sealing member for plug 30. In an alternative embodiment which does not include plug receiving member 20, the sealing function of plug receiving member 20 can be performed by ensuring sufficient contact between a portion of the valve (such as the one or more annular rings 144) and the inner wall of the container perform 10. It will be understood by one of ordinary skill in the art that optional plug receiving member 20 can be made of the same or a different material having a different glass transition temperature to minimize the possibility that the dimensions, inner diameter, inner surface integrity (smoothness and cylindrical shape) of the inner plug receiving member change upon heating and cooling. It is believed that providing the optional plug receiving member 20 decreases the occurrence of deformation resulting from heating process prior to blow molding. This helps ensure a good fit with the plug and or annular rings. That is, the container opening and/or container neck defines the plug receiving member component of the valve. It should be noted that a separate plug receiving member can be used even if plug 30 is placed within a container opening and/or container neck, whereby a single plug could be used in different sized container openings by varying the outer diameter of the plug receiving member.

The plug receiving member component is preferably made from a material that is rigid enough to provide a sealing surface for the associated plug component. Suitable materials may include, for example, plastics such as polyolfins, polyesters, polycarbonates; metal, wood, glass, and cardboard (can be coated with a hydrophobic material such as a wax). In one exemplary embodiment, the plug receiving member comprises a thermoplastic material and is made by injection molding. Other materials and manufacturing techniques may be used. The plug component is shown as a unitary body in the figures. In this configuration, the entire plug is elastically deformable such as, for example, being made from an elastomeric material (e.g., natural or synthetic rubber). In other embodiments (not shown), the plug can be made from two or more distinct parts and/or materials whereby only a portion of the plug is meant to be elastically deformable. By way of example only, the respective ends of the plug could be made from a thermoplastic and the middle section be made from an elastomeric material. In such a configuration, the separate sections can be made in distinct operations and then assembled, or can be made by multi-component molding techniques (e.g., dual injection molding with a thermoplastic material and a thermoplastic elastomer material (TPE)). Multi-component molding techniques may also be used for molding the plug and plug receiving member both in a single mold assembly (including molds with rotatable sections). Nonlimiting examples of elastomeric materials also include materials having elastic modulus sufficient to allow the plug to deform longitudinally and contract radially when a longitudinal force is applied into the blind hole toward said second end. In one embodiment, the elastomeric material has an elastic modulus of from about 0.01 GPa to about 0.1 GPa.

It should be appreciated that the plug and plug receiving member components can have a variety of different geometries and features as compared to those shown in FIGS. 1-6. By way of example only, the plug and/or plug receiving member can be a right circular cylinder, or in alternative embodiments can be oval, square-shaped, or other. Also, the components are shown as having fairly uniform walls; in other embodiments, the component walls can vary in dimension.

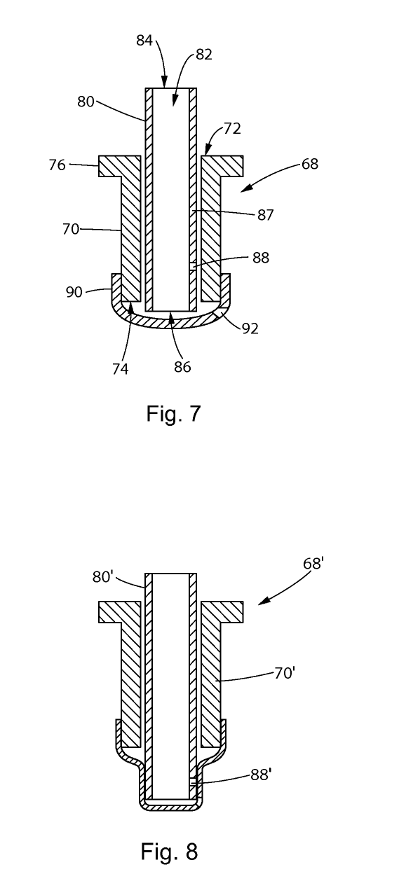

Referring now to FIG. 7, an alternative valve embodiment is shown. Valve 68 includes a bushing 70, a tube 80 slidably disposed within the bushing, and an elastically deformable cap 90 covering an end of the bushing 70. Bushing 70 has a first end 72 and an opposing second end 74. An optional flange 76 is disposed about first end 72 to add in securing valve 68 to a container or other flow device. The bushing may employ other features and/or the valve may employ other components that aid in securing the valve to host devices. Tube 80 includes an internal channel 82, an open end 84, an opposing end 86 (which may be open or closed), a sidewall 87, and a tube hole 88 extending through the sidewall that is in fluid communication with internal channel 82 and open end 84. Elastically deformable cap 90 has a flow passage 92 extending through its wall 94. Flow passage 92 is shown as an open hole in FIG. 7, but could also be a slit or other structure that extends through cap wall 94, which appears to be closed, but can become opened when cap 90 is elastically deformed. Cap 90 is shown as extending up along the exterior of bushing 70, but it can alternately be affixed just to bushing second end 74. The cap may also be indirectly affixed to the bushing by way of one or more components. The cap may be made from any material that is elastically deformable, such as, for example, natural rubber, synthetic rubber, PVC, PU or a thermoplastic elastomer. The bushing and cap may be manufactured together, for example, with a co-molding technique, wherein the bushing is molded out of a thermoplastic and the cap is molded out of a thermoplastic elastomer.

As shown in FIG. 7, the tube hole 88 is located in a section of tube 80 that resides within bushing 70 in the valve's normally closed position. In an alternative valve embodiment 68′ that is shown in FIG. 8, tube hole 88′ is located in a distal section of tube 80′ that is outside of bushing 70′ in the valve's normally closed position. Similar to the embodiment shown in FIG. 6, the tube can form all or part of a conduit associated with an actuator/nozzle component for dispensing compositions from a container employing valves of the present invention. Displacement of the tube in the direction of the elastically deformable cap will elongate/stretch the cap sufficient to permit the tube hole to align with the cap flow passage to convert the valve from a closed position to an open position.

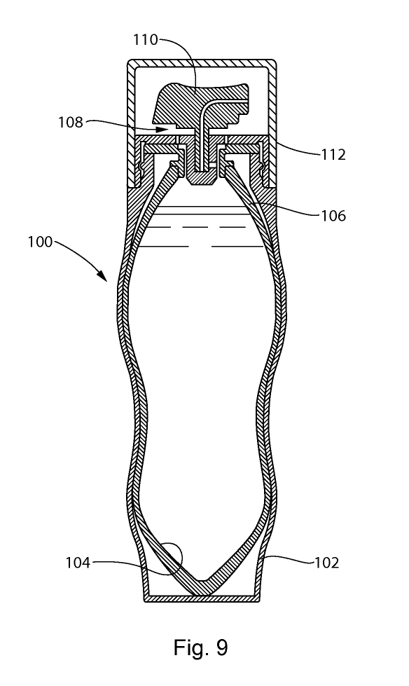

Valves of the present invention can be used in numerous host devices for a variety of applications. One such host device is a dispenser for dispensing flowable compositions. By way of example only and with reference to FIG. 9, a dispenser 100 is shown, including an outer container 102, an inner flexible container 104 that is surrounded by an energy band 106, an exemplary valve 108, an actuator 110, and a closure 112. Although exemplary dispenser 100 utilizes potential energy associated with energy band 106 rather than propellants, valves of the present invention can be used in pressurized dispensers. The pressurized and non-pressurized dispensers employing valves of the present invention can be used to dispense a variety of compositions, including, for example, personal care products (e.g., cosmetics, antiperspirants/deodorants, skin care products, shave care products, fragrances, and hair care products), home care products, air care products, and pet care products.

FIGS. 11 to 28 provide additional exemplary drawings of various plugs and plug receiving members suitable for use in accordance with the present invention.

FIG. 11 is a top planar view of a plug 30 in accordance with at least one embodiment of the present invention. Three different types of flange orifices 42 are shown, one of them being a notch. FIG. 12 is a side planar view of another plug in accordance with the present invention having at least a notch as a flange orifice 42. Said flange orifice allows for a flow passage between the opposing sides of the flange. Those of skill in the art will understand that when the body of the plug is deformed laterally fluid can then pass from the inner flange wall 355 to the outer flange wall 350 and thereby be available for dispersal out of the container.

FIGS. 13 and 14 show two side views of different valve systems, wherein each of the respective plugs include at least one flange orifice. The plug shown in FIG. 14 further includes a radial orifice. As shown in these two figures, the manner in which the inner wall 26 of the plug retaining member engages the plug outer side wall and/or flange can vary. FIG. 14 further demonstrates a plug wherein the blind hole 38 has a larger cross section than the tube 60.

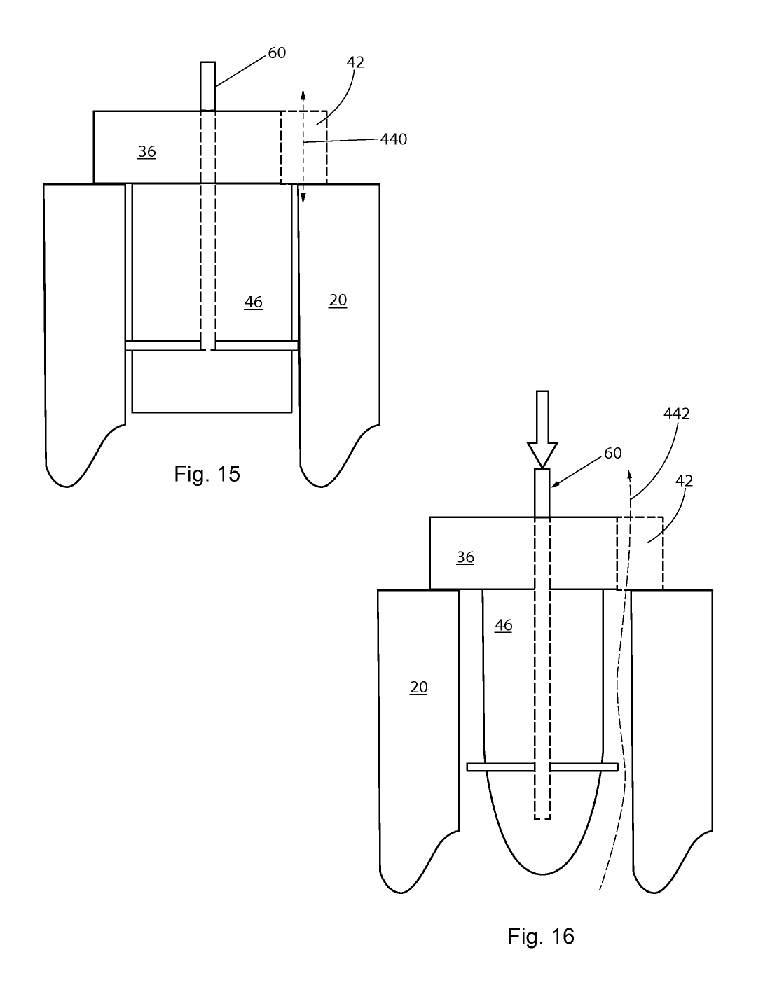

FIGS. 15 and 16 show a valve system in an unstressed state and a stressed state, respectively. A downward stress is applied to the tube in FIG. 16. The stressed plug shown in FIG. 16 shows the plug body deformed longitudinally downward away from the first end of the plug. The plug body has further contracted radially such that the annular flange no longer makes a seal against the inner wall 26 of the plug retaining member. A fluid flowpath 442 is thus formed allowing fluid to travel through the valve system.

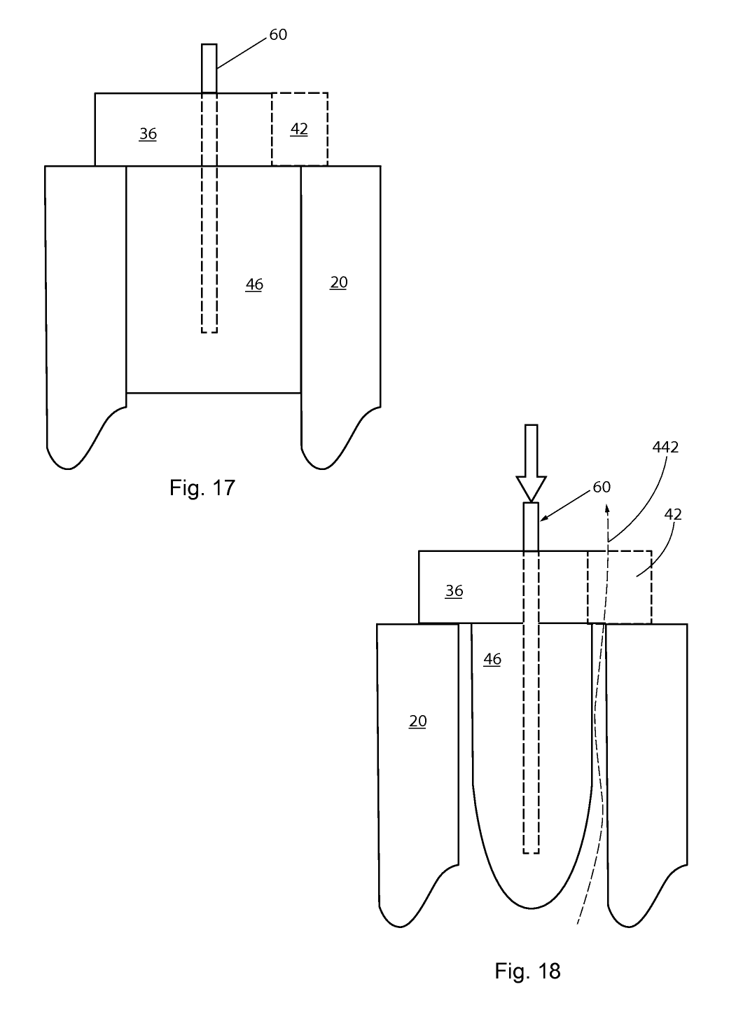

The valve systems shown in FIGS. 17 and 18 are similar to the embodiments shown in FIGS. 15 and 16, except that the plug body does not include an annular flange. In this embodiment, peripheral outer sidewall (46) is sealingly engaged to the inner wall (26) of a plug receiving member when said plug is inserted therein in FIG. 17. The plug body shown in FIG. 18 however is stressed and thereby longitudinally deformed and radially contracted to form a fluid flow path 442.

The plug shown in FIG. 19 shows two radial orifices which are equally circumferentially spaced apart, in this case diametrically opposed. In another embodiment, the radial orifices can be unequally circumferentially spaced apart. The plug shown in FIG. 20, shows two radial orifices which are in the same longitudinal position along the longitudinal axis of the plug. The radial orifices can be in different longitudinal positions. In one embodiment, a plug comprises at least two radial orifices which are diametrically opposed and are in the same longitudinal position, thereby forming a diametric orifice. Combinations of various radial and diametric orifices can be provided in the same plug. FIGS. 21 to 23 exemplify some variations of radial orifice combinations. The plug of the current invention can include various types of orifices, including one or more orifices selected from the group consisting of flange orifices, radial and diametric orifices, or combinations and mixtures thereof. The plug of FIG. 23, further shows a second flange 244 juxtaposed with said second end of the plug, said second flange having an end surface 249 and an underside surface 248 opposed thereto, said underside surface of said second flange capable of sealingly engaging a surface of a plug receiving member when said plug is inserted in a valve system. When the plug is used in a filled dispensing system, pressure built up within the device can create a pressure onto the end surface of the second flange. Further shown in FIG. 23 is a tube 60 having one or more tube orifices 66 which can line up with the orifices 42 formed in the plug body.

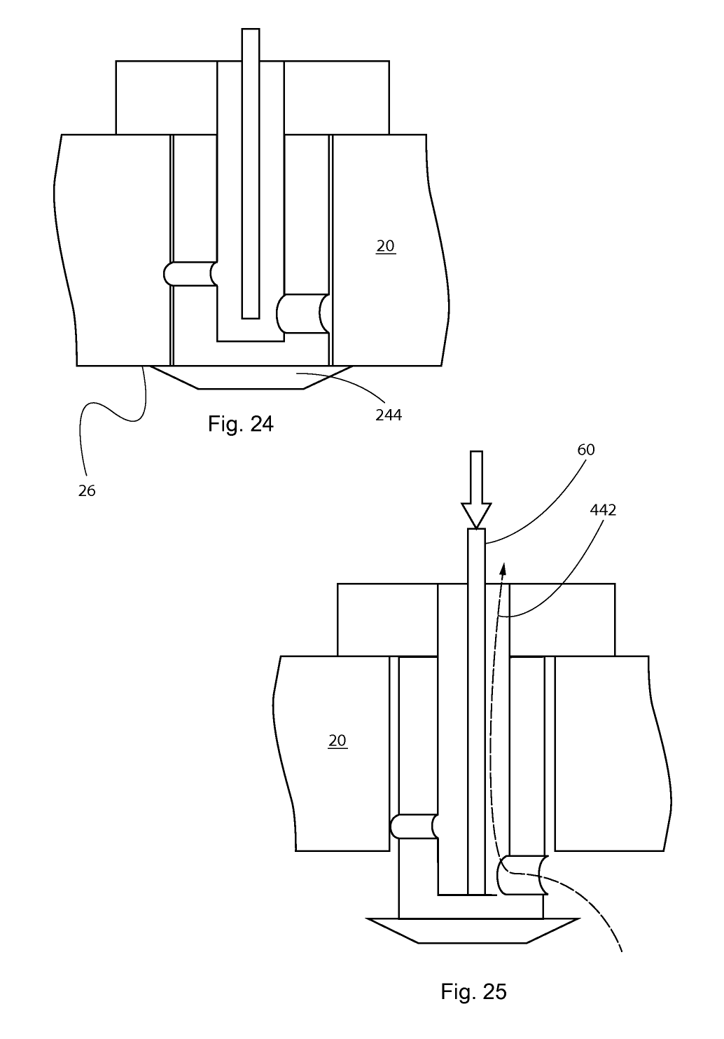

FIGS. 24 and 25 show a valve system with the plug in an unstressed state (FIG. 24), and in a stressed state (FIG. 25). The plug shown in these figures has two radial orifices of varying cross sectional area. In one embodiment, the cross sectional area of the radial orifice which is lower in longitudinal position from the first end has a larger cross sectional area than any other orifice formed in the plug. As shown here, by including varying sizes of orifice, a controlled release profile can be achieved where the more the plug is stretched, the more orifices are exposed from the inner wall 26 of the plug retaining member. Further in one embodiment, the plug comprises a second flange 244. The plug is longitudinally elastically elongatable in response to longitudinal force applied to said blind end of said blind hole (such as by a downward movement of the tube 60) thereby radially contracting the plug body in response to said longitudinal elongation to create the flow path 442 past the second flange, through said at least one orifice. The flow path can flow into the tube or past the tube.

FIG. 26 shows a valve system wherein the plug comprises a flange 36 having a tapered shape, said flange having an outer flange wall 350 and an inner flange wall 355. When the plug is placed into a plug receiving member 20, at least a portion of the inner flange is in contact with the inner surface 26 of the plug retaining member. This engagement forms the seal which prevents fluid from escaping the valve system regardless of when the plug is in a stressed or unstressed state. In one embodiment the seals are substantially water tight. Also shown in the plug shown in FIG. 26 is an orifice 46 formed by both the flange and the plug body.

In one embodiment the plug can be manufactured from a plugs and rubber stoppers such as those commercially available from rubber parts suppliers including but not limited to The Widget Mfg. Co., Inc., Huston, Tex.; Minor Rubber, New Jersey; Mid-Atlantic Rubber Co of Maryland, MOCAP, Inc, St. Louis, Mo.; Non-limiting examples of suitable plugs include their standard plugs which can come with a blind hole preformed or drilled therein after plug molding. Said at least one orifice can be drilled into the plug body via any known drilling method which does not cause the plug body or flange to become overly sensitive to tear under stress. In one embodiment, the plug can also be a single piece molded with said at least one orifice formed therein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A plug for use in a valve system and selectively blocking and admitting fluid flow from a high pressure side of said plug to a low pressure side of said plug when inserted into a plug receiving member, said plug comprising:
a. a generally elongate elastically deformable plug body having a longitudinal axis, a first end, a second end longitudinally opposed thereto, and a peripheral outer sidewall, said outer sidewall sealingly engaging an inner wall of a plug receiving member when said plug is inserted therein;
b. a blind hole disposed in said first end and extending in the longitudinal direction to a blind end, said hole defining an inner sidewall in said elongate body; and
c. a flange juxtaposed with said first end and extending radially outboard of said outer wall, said flange having an inner flange wall and an outer flange wall;
wherein said plug forms at least one orifice extending from at least one of said outer sidewall, said inner flange wall, or a combination thereof, to at least one of said inner sidewall, said outer flange wall, or a combination thereof,
whereby said plug is longitudinally elastically elongatable in response to longitudinal force applied to said blind end of said blind hole; said plug radially contracting in response to said longitudinal elongation, said radial contraction creating a fluid flowpath from said second end to said first end.

2. The plug of claim 1, wherein said at least one orifice is a flange orifice extending from said inner flange wall.

3. The plug of claim 2, wherein said flange orifice extends to the outer flange wall.

4. The plug of claim 3, wherein said flange orifice is a notch in said flange.

5. The plug of claim 2, wherein said flange orifice is formed by a portion of said flange and a portion of said generally elongate elastically deformable plug body.

6. The plug of claim 2, further comprising a plurality of flange orifices.

7. The plug of claim 2, wherein said plurality of flange orifices do not have the same shape.

8. The plug of claim 2, wherein said flange orifice comprises a longitudinal axis which is not parallel to the longitudinal axis of said generally elongate elastically deformable plug body.

9. The plug of claim 1, wherein outer sidewall forms at least one annular ring.

10. The plug of claim 1, wherein said at least one orifice is selected from the group consisting of a tapered in orifice, a tapered out orifice, a non-tapered orifice, a spiral channel, a diagonal orifice, and combinations thereof.

11. The plug of claim 1, wherein said at least one orifice comprises a plurality of orifices.

12. The plug of claim 11, wherein said plurality of orifices are equally circumferentially spaced apart.

13. The plug of claim 2, wherein said at least one orifice further comprises at least one orifice extending from said outer sidewall to at least one of said outer sidewall, said outer flange wall, or a combination thereof.

14. The plug of claim 1, further comprising a second flange juxtaposed with said second end.

15. The plug of claim 14, wherein said second flange does not subtend 360°.

16. A valve system comprising:
a. a plug of claim 1; and
b. a plug receiving member comprising an inner wall such that said outer sidewall of said plug sealingly engages at least a portion of said inner wall of said plug receiving member when said plug is inserted therein.

17. The valve system of claim 16, wherein said plug receiving member is a sleeve.

18. The valve system of claim 15, wherein said plug receiving member forms a part of a container.

19. A valve system comprising:
a. a plug of claim 14; and
b. a plug receiving member comprising an inner wall such that at least a portion of said underside surface of said second flange sealingly engages at least a portion of said inner wall of said plug receiving member when said plug is inserted therein.

20. The valve system of claim 19, wherein said outer sidewall of said plug further sealingly engages at least a portion of said inner wall of said plug receiving member when said plug is inserted therein.
